(19) United States
(12) Patent Application Publication
(10) Pub. No.: US 2017/0149199 A1
(43) Pub. Date: May 25, 2017

(54) LASER DEVICE

(71) Applicant: Gigaphoton Inc., Tochigi (JP)

(72) Inventors: Daisuke TEI, Oyama-shi (JP); Takahito KUMAZAKI, Oyama-shi (JP); Takeshi OHTA, Oyama-shi (JP); Osamu WAKABAYASHI, Oyama-shi (JP)

(73) Assignee: Gigaphoton Inc., Tochigi (JP)

(21) Appl. No.: 15/428,165

(22) Filed: Feb. 9, 2017

Related U.S. Application Data
(63) Continuation of application No. PCT/JP2014/075018, filed on Sep. 22, 2014.

(51) Int. Cl. H01S 3/08; H01S 3/23; H01S 3/225

(52) U.S. Cl. CPC H01S 3/08054; H01S 3/225; H01S 3/2308

(57) ABSTRACT

A laser apparatus includes: an oscillator configured to output seed light; an amplifier including a laser chamber provided in an optical path of the seed light and a pair of discharge electrodes provided inside the laser chamber; and a transform optical system provided in the optical path of the seed light between the oscillator and the amplifier and configured to transform the seed light in a way that suppresses a decrease in purity of polarization of a laser beam that is outputted from the amplifier.

### TECHNICAL FIELD

The present disclosure relates to a laser device.

### BACKGROUND ART

In recent years, along with the miniaturization and integration of semiconductor integrated circuits, a semiconductor exposure device has been required to have higher resolution. The semiconductor exposure device is hereinafter referred to simply as “exposure device”. For this reason, shortening of the wavelength of light that is emitted from an exposure light source has been under development. Generally, as an exposure light source, a gas laser apparatus is used instead of a conventional mercury lamp. For example, as a gas laser apparatus for exposure, a KrF excimer laser apparatus configured to output ultraviolet laser beam with a wavelength of 248 nm as well as an ArF excimer laser apparatus configured to output ultraviolet laser beam with a wavelength of 193 nm may be used.

As a current exposure technology, immersion exposure has been put to practical use. In the immersion exposure, a gap between an exposure lens and a wafer in an exposure apparatus is filled with fluid such as water to change refractive index in the gap, such that an apparent wavelength of the light from the exposure light source is shortened. In a case where immersion exposure is performed using an ArF excimer laser apparatus as an exposure light source, a wafer is irradiated with ultraviolet light whose wavelength in water is equivalent to 134 nm. This technique is referred to as “ArF immersion exposure”. The ArF immersion exposure is also referred to as “ArF immersion lithography”.

Spectrum line widths of KrF and ArF excimer laser apparatuses in natural oscillation amplitudes are as wide as approximately 350 pm to 400 pm. This causes a chromatic aberration of a laser beam (ultraviolet light) that is subjected to reduced projection onto a wafer by a projection lens in an exposure device, thus causing deterioration in resolution. Therefore, a spectrum line width of a laser beam that is outputted from a gas laser apparatus needs to be narrowed to such an extent that the chromatic aberration can be ignored. The spectrum line width is also referred to as “spectrum width”. For the reason mentioned above, narrowing of a spectrum width is achieved by providing, in a laser resonator of a gas laser apparatus, a line narrow module having a line narrow element. Thee line narrow element may be an etalon, a grating, or the like. A laser apparatus whose spectrum width is narrowed in this way is referred to as “line narrowed laser apparatus”.

### SUMMARY

A laser apparatus according to an aspect of the present disclosure may include: an oscillator configured to output seed light; an amplifier including a laser chamber provided in an optical path of the seed light and a pair of discharge electrodes provided inside the laser chamber; and a transform optical system provided in the optical path of the seed light between the oscillator and the amplifier and configured to transform the seed light in a way that suppresses a decrease in purity of polarization of a laser beam that is outputted from the amplifier.

### BRIEF DESCRIPTION OF DRAWINGS

Exemplary embodiments of the present disclosure will be described below with reference to the appended drawings.

FIG. 1A schematically illustrates a configuration of an excimer laser apparatus according to a first embodiment.

FIG. 1B is a schematic view of an internal structure of the excimer laser apparatus shown in FIG. 1A as viewed from a V direction.

FIG. 2A illustrates a beam profile of a cross-section of a beam at a line IIA-IIA in FIG. 1A.

FIG. 2B illustrates a beam profile of a cross-section of the beam at a line IIB-IIB in FIG. 1A.

FIG. 2C illustrates a beam profile of a cross-section of the beam at a line IIC-IIC in FIG. 1A.

FIGS. 3A and 3B schematically illustrate a configuration of a transform optical system 31 that is used in an excimer laser apparatus according to a second embodiment.

FIGS. 4A and 4B schematically illustrate a configuration of a transform optical system 32 that is used in an excimer laser apparatus according to a third embodiment.

FIGS. 5A and 5B schematically illustrate a configuration of a transform optical system 33 that is used in an excimer laser apparatus according to a fourth embodiment.

FIG. 6 schematically illustrates a configuration of a transform optical system 34 that is used in an excimer laser apparatus according to a fifth embodiment.

FIG. 7 schematically illustrates a configuration of a transform optical system 35 that is used in an excimer laser apparatus according to a sixth embodiment.

FIGS. 8A and 8B schematically illustrate a configuration of a transform optical system 36 that is used in an excimer laser apparatus according to a seventh embodiment.

FIGS. 9A and 9B schematically illustrate a configuration of a transform optical system 37 that is used in an excimer laser apparatus according to an eighth embodiment.

FIGS. 10A and 10B schematically illustrate a configuration of a transform optical system 38 that is used in an excimer laser apparatus according to a ninth embodiment.

FIG. 11A schematically illustrates a configuration of a transform optical system 39 that is used in an excimer laser apparatus according to a tenth embodiment.

FIG. 11B illustrates an optical path in an amplifier PO in a case where the transform optical system 39 shown in FIG. 11A is used.

FIG. 12 schematically illustrates a configuration of an amplifier PA that is used in an excimer laser apparatus according to an eleventh embodiment.

FIG. 13 schematically illustrates a configuration of an amplifier PO that is used in an excimer laser apparatus according to a twelfth embodiment.

### DESCRIPTION OF EMBODIMENTS

Contents

### 1. Outline

### 2. Excimer Laser Apparatus Including Transform Optical System (First Embodiment)

### 2.1 Oscillator MO

### 2.2 High Reflection Mirrors 18a and 18b

### 2.3 Amplifier PO

### 2.4 Transform Optical System 30

### 3. Transform Optical System Configured to Transform Seed Light to Have a Top-hat Shape

### 3.1 Second Embodiment

### 3.2 Third Embodiment

### 4. Transform Optical System Configured to Beam-expand Seed Light

### 4.1 Fourth Embodiment

### 4.2 Fifth Embodiment

### 4.3 Sixth Embodiment

5. Transform Optical System Configured to Split Seed Light into Two Beams

### 5.1 Seventh Embodiment

### 5.2 Eighth Embodiment

### 5.3 Ninth Embodiment

### 5.4 Tenth Embodiment

### 6. Variations of Amplifiers

### 6.1 Eleventh Embodiment

### 6.2 Twelfth Embodiment

Embodiments of the present disclosure will be described in detail below with reference to the drawings. The embodiments described below indicate several examples of the present disclosure, and are not intended to limit the content of the present disclosure. Not all of the configurations and operations described in the embodiments are indispensable in the present disclosure. Identical constituent elements may be given identical reference symbols, and redundant descriptions thereof may be omitted.

### 1. Outline

In an excimer laser apparatus that is used as a light source of an exposure device, a double chamber laser apparatus including an oscillator and an amplifier has been put to practical use to meet the demand for higher output power. The double chamber laser apparatus can take either of the two following forms: an MOPA (master oscillator power amplifier) laser apparatus whose amplifier is provided with no resonator mirror and an MOPO (master oscillator power oscillator) laser apparatus whose amplifier is provided with resonator mirrors. Such an excimer laser apparatus is used to perform multiple-exposure such as double patterning or triple patterning, however, still higher output power is required for throughput improvement.

With higher output power, a laser apparatus could output a laser beam with a decreased purity of polarization. The decreased purity of polarization could adversely affect exposure performance. Further, the decreased purity of polarization could cause a reflection loss in a transmitting optical element such as a window, thus causing a decrease in amplification efficiency. The purity of polarization may be a value that indicates the rate of linearly polarized light having a desired polarization direction in the light to be measured. The purity of polarization P is defined by the following equation:

P=(I₁−I₂)/(I₁I+₂)×100 (%)

where I₁ is the light intensity of a predetermined polarization component and I₂ is the light intensity of a polarization component orthogonal to the predetermined polarization component.

According to an aspect of the present disclosure, a transform optical system configured to transform the seed light in a way that suppresses a decrease in purity of polarization of a laser beam that is outputted from the amplifier may be disposed between the oscillator and the amplifier.

### 2. Excimer Laser Apparatus Including Transform Optical System (First Embodiment)

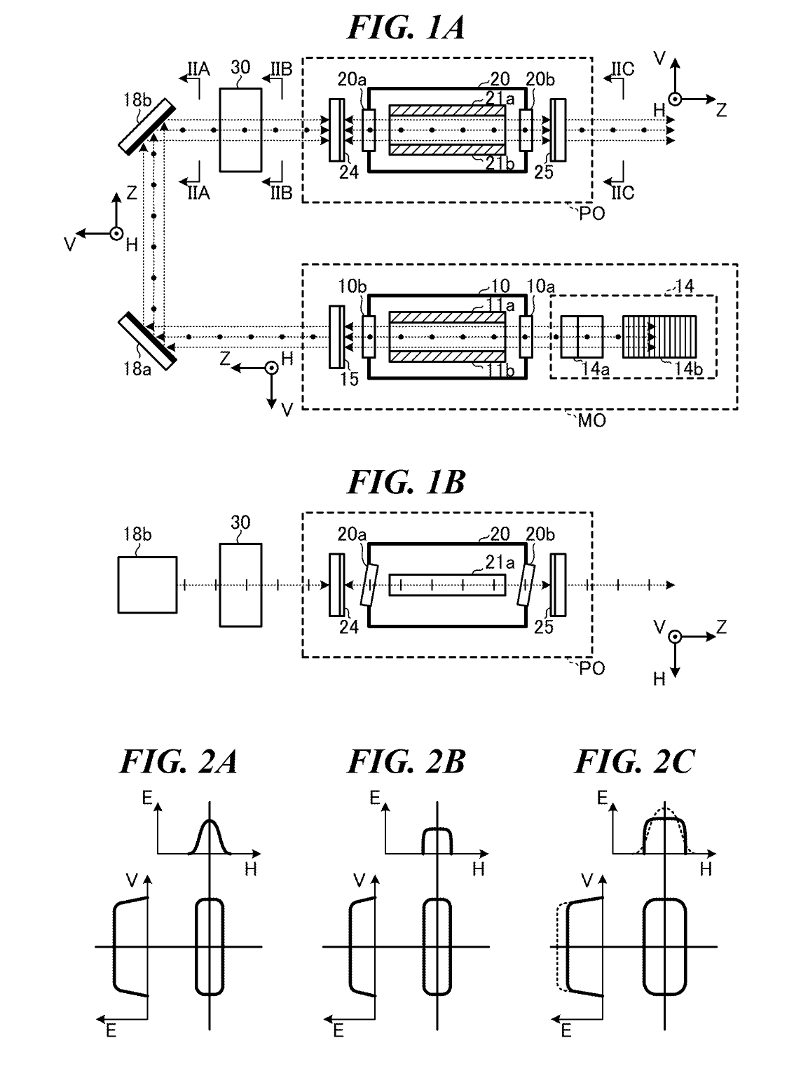

FIG. 1A schematically illustrates a configuration of an excimer laser apparatus according to a first embodiment. As shown in FIG. 1A, the excimer laser apparatus may include an oscillator MO, an amplifier PO, high reflection mirrors 18a and 18b, and a transform optical system 30.

### 2.1 Oscillator MO

The oscillator MO may include a laser chamber 10, a pair of discharge electrodes 11a and 11b, a line narrow module 14, and an output coupling mirror 15. The oscillator MO may be a master oscillator configured to perform laser oscillation to output seed light that enters the amplifier PO.

FIG. 1A illustrates an internal structure of the laser chamber 10 as viewed from a direction substantially perpendicular to the direction of travel of a laser beam inside the oscillator MO and substantially perpendicular to the direction of discharge between the pair of discharge electrodes 11a and 11b. In FIG. 1A, the direction of travel of a laser beam nay be a Z direction or a direction. The direction of discharge between the pair of discharge electrodes 11a and 11b may be a V direction. A direction perpendicular to both of these directions may be an H direction. When the high reflection mirror 18a or 18b changes the direction of travel of a laser beam, the Z direction and the V direction may change according to the change in the direction of travel.

The laser chamber 10 may be a chamber containing a laser gas serving as a laser medium, which includes, for example, argon, neon, fluorine, and the like. The pair of discharge electrodes 11a and 11b may be disposed within the laser chamber 10 as electrodes for exciting the laser medium by a discharge. A pulsed high voltage may be applied to the pair of discharge electrodes 11a and 11b from a pulse power module (not illustrated).

When the high voltage is applied between the pair of discharge electrodes 11a and 11b, a discharge may occur between the pair of discharge electrodes 11a and 11b. The laser medium in the laser chamber 10 may be excited by the energy of the discharge and may shift to a high energy level. When the excited laser medium shifts back to a low energy level, light depending on the difference between the energy levels may be emitted.

Windows 10a and 10b may be provided at both ends of the laser chamber 10, respectively. Although not shown in FIG. 1A, the windows 10a and 10b may be disposed so that the plane of incidence of light on these windows and the HZ plane substantially coincide with each other and the angle of incidence of this light is equivalent to a Brewster's angle. The plane of incidence may mean a plane that includes the optical axis of incident light and a line normal to a boundary surface on which this light is incident. The light generated in the laser chamber 10 may be emitted to the outside of the laser chamber 10 via the windows 10a and 10b.

The line narrow module 14 may include a prism 14a and a grating 14b. The prism 14a may expand the beam width in the H direction of the light emitted through the window 10a of the laser chamber 10, and may allow the light to fall on the grating 14b. Further, the prism 14a may reduce the beam width in the H direction of reflected light from the grating 14b, and may transmit the light toward the laser chamber 10. In addition, when transmitting light, the prism 14a may refract the light at different angles in accordance with the wavelength of the light. Accordingly, the prism 14a may also function as a wavelength dispersion element. Furthermore, the prism 14a may be disposed so that the plane of incidence of light on an oblique surface of the prism 14a substantially coincides with the HZ plane. The oblique surface of the prism 14a may be coated with a film that suppresses reflection of p-polarized light.

The grating 14b may be made of a high-reflectance material, and may have a large number of grooves formed at predetermined intervals on a surface of the grating 14b. Each of the grooves may, for example, be a triangular groove. The grating 14b may be in a Littrow arrangement so that the angle of incidence of light falling on the grating 14b from the prism 14a and the angle of diffraction of diffracted light of a desired wavelength coincide with each other. This may cause light near the desired wavelength to be returned to the laser chamber 10 via the prism 14a. Accordingly, the grating 14b may function as a wavelength dispersion element.

In this manner, the line narrow module 14 may be constituted by the prism 14a and the grating 14b to reduce the spectral width of a laser beam.

The output coupling mirror 15 may have a surface coated with a partial reflection film. Accordingly, the output coupling mirror 15 may transmit and output a portion of the light outputted through the window 10b of the laser chamber 10, and may reflect another portion of the light back into the laser chamber 10.

The line narrow module 14 and the output coupling mirror 15 may constitute an optical resonator. The light emitted from the laser chamber 10 may travel back and forth between the line narrow module 14 and the output coupling mirror 15, and may be amplified and subjected to laser oscillation each time it passes through a laser gain space between the discharge electrodes 11a and 11b. The laser beam may be subjected to line narrowing by traveling back and forth between the line narrow module 14 and the output coupling mirror 15, and a polarization component in the H direction may be selected by the aforementioned disposition of the windows 10a and 10b. As a result, a pulse laser beam may be outputted as seed light from the output coupling mirror 15. The seed light thus outputted may be linearly polarized light having a direction of polarization in a direction (H direction) substantially orthogonal to the direction of discharge between the discharge electrodes 11a and 11b.

### 2.2 High Reflection Mirrors 18a and 18b

The high reflection mirrors 18a and 18b may be disposed to reflect, at a high reflectance, the seed light outputted from the oscillator MO and guide the seed light toward the transform optical system 30.

The transform optical system 30 may be an optical system configured to transform the beam profile or beam width of the seed light and output the seed light toward the amplifier PO. The transform optical system 30 will be described later.

### 2.3 Amplifier PO

FIG. 1B is a schematic view of a part of an internal structure of the excimer laser apparatus shown in FIG. 1A as viewed from the V direction. The amplifier PO is described with reference to FIGS. 1A and 1B. The amplifier PO may include a laser chamber 20, a pair of discharge electrodes 21a and 21b, a rear mirror 24, and an output coupling mirror 25. The amplifier PO may include an optical resonator constituted by the rear mirror 24 and the output coupling mirror 25 and the laser chamber 20 disposed in this optical resonator. This amplifier PO may be a power oscillator configured to oscillate while amplifying seed light once the seed light is introduced into the optical resonator and output a laser beam as output light toward an exposure device (not illustrated) or the like.

The laser chamber 20, the pair of discharge electrodes 21a and 21b, and the output coupling mirror 25 may be similar in configuration to the laser chamber 10, the pair of discharge electrodes 11a and 11b, and the output coupling mirror 15 of the oscillator MO. Windows 20a and 20b may be provided at both ends of the laser chamber 20, respectively. As shown in FIG. 1B, the windows 20a and 20b may be disposed so that the plane of incidence substantially coincides with the HZ plane and the angle of incidence is equivalent to a Brewster's angle.

The rear mirror 24 may be an element configured to reflect a portion of a laser beam and transmit another portion of the laser beam. The rear mirror 24 may be disposed to guide the seed light, falling on the rear mirror 24 via the transform optical system 30, into the laser chamber 20. By the rear mirror 24 transmitting a portion of the seed light, the seed light may be introduced into the optical resonator constituted by the rear mirror 24 and the output coupling mirror 25. The rear mirror 24 may have a reflectance of 90% or lower and 70% or higher and the output coupling mirror 25 may have a reflectance of 20% or higher and 40% or lower.

A pulsed high voltage may be applied to the pair of discharge electrodes 21a and 21b from a pulse power module (not illustrated). The timing of application of the pulsed high voltage to the pair of discharge electrodes 21a and 21b may be synchronized with the timing of inputting of the seed light to the amplifier PO. The direction of polarization of the seed light entering via the transform optical system 30 may substantially coincide with the H direction orthogonal to the direction of discharge between the discharge electrodes 21a and 21b. Laser oscillation may be performed by the seed light traveling back and forth between the rear mirror 24 and the output coupling mirror 25. The laser beam thus amplified may be outputted as output light from the output coupling mirror 25. If there is no influence of birefringence in the windows 20a and 20b, the polarization properties of the laser beam that is outputted from the amplifier PO may substantially coincide with the polarization properties of the seed light.

### 2.4 Transform Optical System 30

FIG. 2A illustrates a beam profile of a cross-section of the beam at a line IIA-IIA, in FIG. 1A. FIG. 2B illustrates a beam profile of a cross-section of the beam at a line IIB-IIB in FIG. 1A. FIG. 2C illustrates a beam profile of a cross-section of the beam at a line IIC-IIC in FIG. 1A.

As shown in FIG. 2A, the cross-section of the seed light that is outputted from the oscillator MO may have a shape that is long in the direction of discharge, i.e. the V direction, or may have a substantially rectangular shape. Furthermore, a beam profile in the V direction of the seed light that is outputted from the oscillator MO may have a substantially top-hat shape having a substantially uniform energy density. Further, a beam profile in the H direction of the seed light that is outputted from the oscillator MO may have a Gaussian distribution shape having a high energy density near the center and having a low energy density near either end.

When the seed light having the beam profile mentioned above is amplified by entering the amplifier PO without passing through the transform optical system 30, the energy density near the center of the beam profile in the H direction may become still higher. Optical elements such as the windows 20a and 20b through which the laser beam passes may be heated by absorption of energy of light. In particular, an increase in the absorption of the energy of light near the center of the beam profile in the H direction may bring about unevenness in temperature in each optical element and thus generate thermal stress in the optical element. The thermal stress may cause birefringence of light passing through the optical element, causing the linearly polarized light to be transformed into elliptically polarized light, and thus decrease the purity of polarization. This may result in deterioration of the imaging performance of the exposure device. Further, the lives of the optical elements may be shortened.

To address these problems, the transform optical system 30 may, for example, be provided to transform a Gaussian distribution beam profile in the H direction into a substantially top-hat shaped beam profile. As can be seen from a comparison between FIGS. 2A and 2B, the transformation of the Gaussian distribution beam profile into the substantially top-hat shaped beam profile may cause a decrease in energy density in the center of the beam profile. Entering into the amplifier PO of the seed light having a substantially top-hat shaped beam profile in the H direction may suppress the unevenness in temperature in each of the optical elements such as the windows 20a and 20b. This may suppress the birefringence caused by the thermal stress and thus suppress the decrease in the purity of polarization. This may result in suppression of the deterioration of the imaging performance of the exposure device.

In a case where the seed light having a substantially top-hat shaped beam profile in the H direction enters the amplifier PO, a laser beam that is outputted from the amplifier PO may also have a substantially top-hat shaped beam profile in the H direction as indicated by a solid line in FIG. 2C. In FIG. 2C, broken lines show a beam profile of a laser beam that is outputted from the amplifier PO in a case where the seed light having a Gaussian distribution beam profile in the H direction enters the amplifier PO without passing through the transform optical system 30. As can be seen from FIG. 2C, in a case where the seed light enters the amplifier PO after passing through the transform optical system 30, a decrease may be caused in energy density in the central part of the beam profile of the laser beam that is outputted from the amplifier PO. Moreover, the laser beam that is outputted from the amplifier PO may have a substantially top-hat shaped beam profile in the H direction. This may suppress the unevenness in temperature in the windows 20a and 20b and thus suppress the birefringence caused by the thermal stress. This may result in suppression of the decrease in the purity of polarization of the laser beam that is outputted from the amplifier PO.

The transform optical system 30 may be provided between the high reflection mirrors 18a and 18b or between the oscillator MO and the high reflection mirror 18a, as well as between the high reflection mirror 18b and the amplifier PO.

### 3. Transform Optical System Configured to Transform Seed Light to Have a Top-hat Shape

The following second and third embodiments describe specific configurations of transform optical systems each configured to transform seed light so that the seed light has a substantially top-hat beam profile in a direction orthogonal to the direction of discharge between the pair of discharge electrodes 21a and 21b.

### 3.1 Second Embodiment

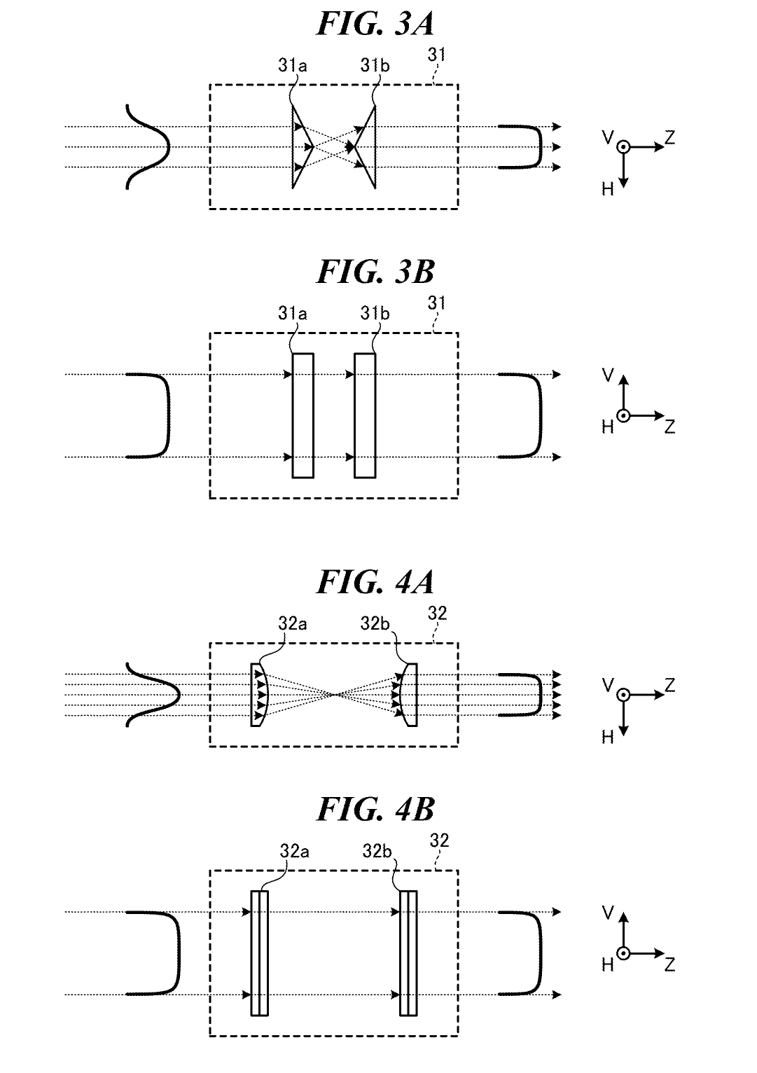

FIGS. 3A and 3B schematically illustrate a configuration of a transform optical system 31 that is used in an excimer laser apparatus according to the second embodiment. FIG. 3A shows a view from the V direction, and FIG. 3B shows a view from the H direction. The excimer laser apparatus according to the second embodiment may be the same as that according to the first embodiment, except that the transform optical system 31 is used.

The transform optical system 31 may include two prisms 31a and 31b. The prisms 31a and 31b may each have an isosceles triangular cross-section parallel to the ZH plane. The isosceles triangular cross-sections of the prisms 31a and 31b may have equal vertex angles and the prisms 31a and 31b may be disposed so that these vertex angles face each other.

Seed light whose beam profile in the H direction has a Gaussian distribution shape may enter the prism 31a. When the seed light passes through the prism 31a, a portion of the beam width of the seed light in the H direction which is on the side of the positive direction of the H axis may be refracted and travel toward the side of the negative direction of the H axis and a portion of the beam width which is on the side of the negative direction of the H axis may be refracted and travel toward the side of the positive direction of the H axis. The distance where each of these portions travels may, for example, be a half width at half maximum of the seed light having entered the prism 31a. By passing through the prism 31b, the seed light may turn into seed light having about the same beam divergence as the seed light that is to enter the prism 31a and having a substantially top-hat shaped beam profile.

As shown in FIG. 3B, the beam profile in the V direction may not substantially change.

### 3.2 Third Embodiment

FIGS. 4A and 4B schematically illustrate a configuration of a transform optical system 32 that is used in an excimer laser apparatus according to the third embodiment. FIG. 4A shows a view from the V direction, and FIG. 4B shows a view from the H direction. The excimer laser apparatus according to the third embodiment may be the same as that according to the first embodiment, except that the transform optical system 32 is used.

The transform optical system 32 may include two cylindrical convex lenses 32a and 32b. The cylindrical convex lenses 32a and 32b may each have a flat surface parallel to the VH plane and a cylindrical surface having a central axis parallel to the V axis. The cylindrical convex lenses 32a and 32b may be disposed so that their respective cylindrical surfaces face each other and the focal positions of the cylindrical convex lenses 32a and 32b substantially coincide with each other.

Seed light whose beam profile in the H direction has a Gaussian distribution shape may be subjected to redistribution of the distribution of energy density in the H direction by passing though the cylindrical convex lens 32a and may then enter the cylindrical convex lens 32b. The cylindrical convex lens 32b may correct a wave front distorted by the cylindrical convex lens 32a. Seed light to be emitted from the cylindrical convex lens 32b may have substantially the same beam divergence as the seed light entering the cylindrical convex lens 32a and have a substantially top-hat shaped beam profile.

As shown in FIG. 4B, the beam profile in the V direction may not substantially change.

### 4. Transform Optical System Configured to Beam-expand Seed Light

In each of the following fourth to sixth embodiments, a transform optical system may beam-expand seed light in a direction orthogonal to the direction of discharge between the pair of discharge electrodes 21a and 21b.

### 4.1 Fourth Embodiment

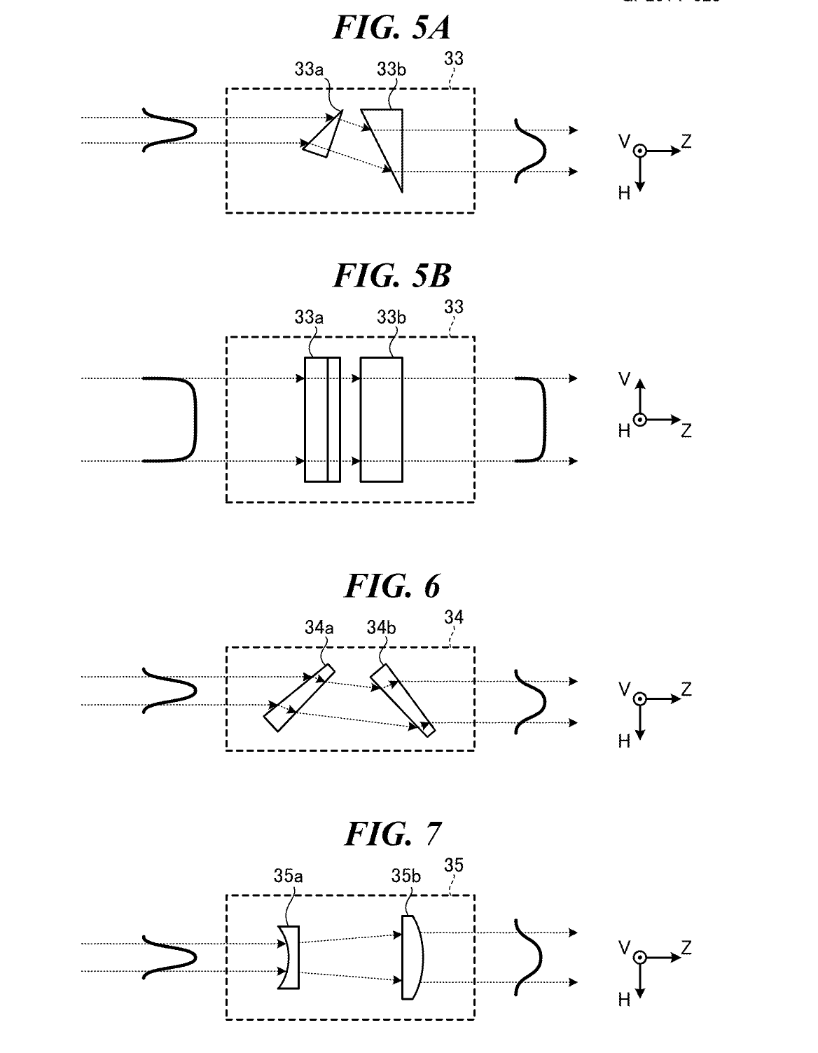

FIGS. 5A and 5B schematically illustrate a configuration of a transform optical system 33 that is used in an excimer laser apparatus according to the fourth embodiment. FIG. 5A shows a view from the V direction, and FIG. 5B shows a view from the H direction. The excimer laser apparatus according to the fourth embodiment may be the same as that according to the first embodiment, except that the transform optical system 33 is used.

The transform optical system 33 may include two prisms 33a and 33b. The prisms 33a and 33b may each have a triangular cross-section parallel to the ZH plane.

The seed light may be beam-expanded in the H direction by falling obliquely on one surface of the prism 33a and be further beam-expanded in the H direction by falling obliquely on one surface of the prism 33b. The direction of travel of the seed light exiting from the prism 33b may be substantially the same as the direction of travel of the seed light that is to enter the prism 33a. The beam expansion ratio in the H direction of the seed light exiting from the prism 33b to the seed light that is to enter the prism 33a may be 1.2 or higher and 1.3 or lower.

A beam profile of the seed light exiting from the prism 33b may have a similar Gaussian distribution shape to that of the seed light that is to enter the prism 33a. However, as compared with the seed light that is to enter the prism 33a, the seed light exiting from the prism 33b may be beam-expanded in the H direction and thus have decreased energy density across the whole beam profile. This may decrease the energy density in the central part of the beam profile and thus suppress the unevenness in temperature in the optical elements such as the windows 20a and 20b. This may suppress the birefringence by the thermal stress and thus suppress the decrease in the purity of polarization. This may result in suppression of the deterioration of the imaging performance of the exposure device.

The beam width in the H direction of the seed light exiting from the prism 33b may be larger than the width in the H direction of an amplification region in the amplifier PO. That is, among the seed light beam-expanded in the H direction, both end portions having low energy density may not enter the amplification region of the amplifier PO. A beam expander formed by the prisms 33a and 33b may cause the optical axis of the laser beam exiting from the prism 33b to be shifted from that of the laser beam that is to enter the prism 33a. To put the optical axis of the laser beam substantially back in place, a parallel plane substrate (not illustrated) that shifts back the optical axis of the laser beam may be provided. This parallel plane substrate may be disposed so that the plane of incidence and the HZ plane substantially coincide with each other and the angle of incidence is equivalent to a Brewster's angle.

As shown in FIG. 5B, the beam profile and beam width in the V direction may not substantially change.

### 4.2 Fifth Embodiment

FIG. 6 schematically illustrates a configuration of a transform optical system 34 that is used in an excimer laser apparatus according to the fifth embodiment. FIG. 6 shows a view from the V direction, The excimer laser apparatus according to the fifth embodiment may be the same as that according to the fourth embodiment, except that the transform optical system 34 is used.

The transform optical system 34 may include two wedge substrates 34a and 34b. The wedge substrates 34a and 34b may each have a tapered thickness.

The seed light may fall obliquely on one surface of the wedge substrate 34a to be beam-expanded in the H direction and be fall obliquely on one surface of the wedge substrate 34b to be further beam-expanded in the H direction. The direction of travel of the seed light exiting from the wedge substrate 34b may be substantially the same as the direction of travel of the seed light that is to enter the wedge substrate 34a.

A beam profile of the seed light exiting from the wedge substrate 34b may have a similar Gaussian distribution shape to that of the seed light that is to enter the wedge substrate 34a. However, as compared with the seed light that is to enter the wedge substrate 34a, the seed light exiting from the wedge substrate 34b may be beam-expanded in the H direction and thus have decreased energy density across the whole beam profile. This may decrease the energy density in the central part of the beam profile and thus suppress the unevenness in temperature in the optical elements such as the windows 20a and 20b. Since the optical axis is shifted in this case, too, the optical axis may be put back in place by providing a parallel plane substrate (not illustrated).

As in the case of the fourth embodiment, the beam profile and beam width in the V direction may not substantially change.

### 4.3 Sixth Embodiment.

FIG. 7 schematically illustrates a configuration of a transform optical system 35 that is used in an excimer laser apparatus according to the sixth embodiment. FIG. 7 shows a view from the V direction. The excimer laser apparatus according to the sixth embodiment may be the same as that according to the fourth embodiment, except that the transform optical system 35 is used.

The transform optical system 35 may include a cylindrical concave lens 35a and a cylindrical convex lens 35b. The cylindrical concave lens 35a and the cylindrical convex lens 35b may each have a flat surface parallel to the VH plane and a cylindrical surface having a central axis parallel to the V axis. The focal length of the cylindrical convex lens 35b may be longer than the focal length of the cylindrical concave lens 35a. The cylindrical concave lens 35a and the cylindrical convex lens 35b may be disposed so that the positions of their front focal points substantially coinciding with each other.

The seed light may be beam-expanded in the H direction by passing through the cylindrical concave lens 35a.

A beam profile of the seed light exiting from the cylindrical convex lens 35b may have a similar Gaussian distribution shape to that of the seed light that is to enter the cylindrical concave lens 35a. However, as compared with the seed light that is to enter the cylindrical concave lens 35a, the seed light exiting from the cylindrical convex lens 35b may be beam-expanded in the H direction and thus have decreased energy density across the whole beam profile. This may decrease the energy density in the central part of the beam profile and thus suppress the unevenness in temperature in the optical elements such as the windows 20a and 20b.

As in the case of the fourth embodiment, the beam profile and beam width in the V direction may not substantially change.

5. Transform Optical System Configured to Split Seed Light into Two Beams

In each of the following seventh to tenth embodiments, a transform optical system may transform seed light into two split beams placed side by side in a direction orthogonal to the direction of discharge between the pair of discharge electrodes 21a and 21b.

### 5.1 Seventh Embodiment

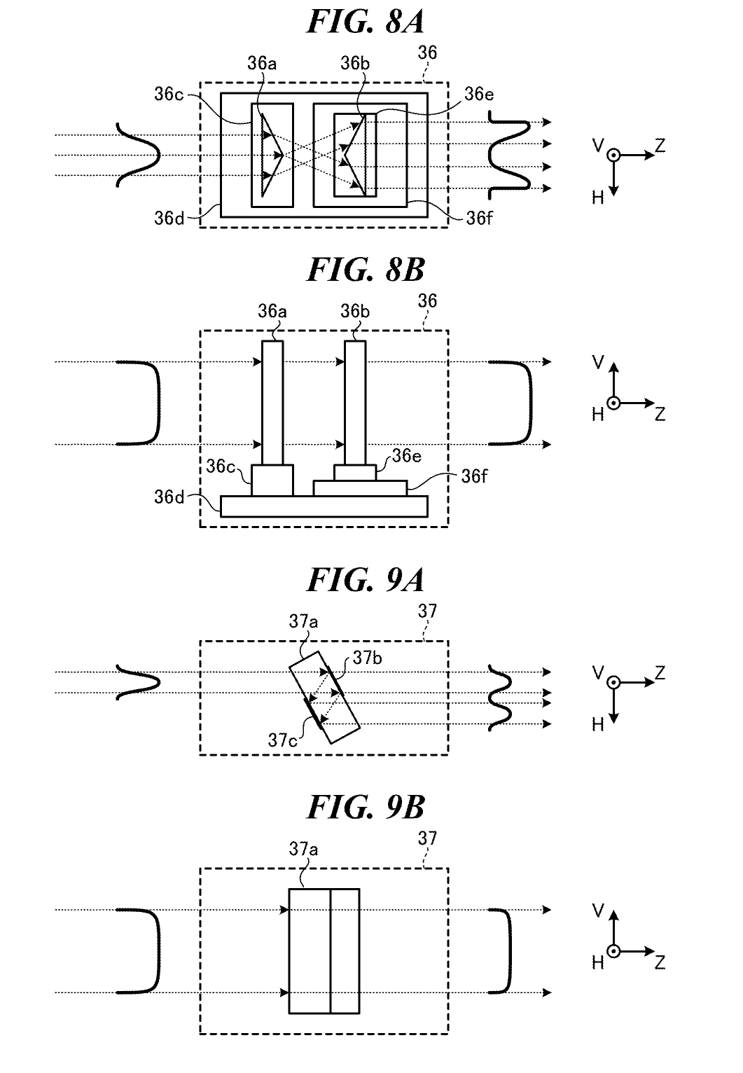

FIGS. 8A and 8B schematically illustrate a configuration of a transform optical system 36 that is used in an excimer laser apparatus according to the seventh embodiment. FIG. 8A shows a view from the V direction, and FIG. 8B shows a view from the H direction. The excimer laser apparatus according to the seventh embodiment may be the same as that according to the first embodiment, except that the transform optical system 36 is used.

The transform optical system 36 may include two prisms 36a and 36b. The prisms 36a and 36b may each have an isosceles triangular cross-section parallel to the ZH plane. The isosceles triangular cross-sections of the prisms 36a and 36b may have equal vertex angles and the prisms 36a and 36b may be disposed so that these vertex angles face each other.

The prism 36a may be fixed to a holder 36c at a position where the seed light is incident. The holder 36c may be fixed to a fixed plate 36d.

The prism 36b may be supported by a holder 36e at a position where the seed light having passed through the prism 36a is incident. The holder 36e may be supported by the fixed plate 36d via a linear stage 36f. The linear stage 36f may support the holder 36e so that the prism 36b supported by the holder 36e may reciprocate with respect to the fixed plate 36d along the optical axis of the seed light.

Seed light whose beam profile in the H direction has a Gaussian distribution shape may enter the prism 36a. When the seed light passes through the prism 36a, a portion of the beam width of the seed light in the H direction which is on the side of the positive direction of the H axis may be refracted and travel toward the side of the negative direction of the H axis and a portion of the beam width which is on the side of the negative direction of the H axis may be refracted and travel toward the side of the positive direction of the H axis. The distance where each of these portions travels may, for example, be greater than a half width at half maximum of the seed light having entered the prism 36a. By passing through the prism 36b, the beam profile in the H direction of the seed light may turn into a beam profile having a low-energy-density depression in the central part of the beam profile and having one peak of energy density at either end of the beam profile. One of the peaks at both ends may constitute a first split beam, and the other peak may constitute a second split beam.

The size of the depression in the beam profile in the H direction of the seed light that is outputted from the prism 36b may be adjustable by moving the prism 36b by the linear stage 36f.

As shown in. FIG. 8B, the beam profile in the V direction may not substantially change.

In general, the central part of discharge in an amplifier may be strong in excitation and high in gain. Accordingly, by causing seed light having a low-energy-density depression in the central part of the beam profile in the H direction to be amplified by entering the amplifier PO, output light that is outputted from the amplifier PO may have a beam profile that is equivalent to a top-hat shape. This may suppress the unevenness in temperature in the optical elements such as the windows 20a and 20b. This may suppress the birefringence by the thermal stress and thus suppress the decrease in the purity of polarization.

### 5.2 Eighth Embodiment

FIGS. 9A and 9B schematically illustrate a configuration of a transform optical system 37 that is used in an excimer laser apparatus according to the eighth embodiment. FIG. 9A shows a view from the V direction, and FIG. 9B shows a view from the H direction. The excimer laser apparatus according to the eighth embodiment may be the same as that according to the seventh embodiment, except that the transform optical system 37 is used.

The transform optical system 37 may include a parallel plane substrate 37a. The parallel plane substrate 37a may be disposed so that the plane of incidence of the seed light and the HZ plane substantially coincide with each other and the angle of incidence is equivalent to a Brewster's angle.

The parallel plane substrate 37a may be coated with an anti-reflection film (not illustrated) in a position of incidence of the seed light on the parallel plane substrate 37a. The parallel plane substrate 37a may be coated with a partial reflection film 37b in a first position of emission of the seed light having fallen on the parallel plane substrate 37a. The partial reflection film 37b may transmit a portion of the seed light as a first split beam toward the amplifier PO and reflect another portion of the seed light toward an incident side surface of the parallel plane substrate 37a. The parallel plane substrate 37a may be coated with a high reflection film 37c in a part of the incident side surface. The seed light reflected by the partial reflection film 37b is reflected by the high reflection film 37c at a high reflectance and transmitted as a second split beam toward the amplifier PO through a second position of emission of the parallel plane substrate 37a. The parallel plane substrate 37a may be coated with an anti-reflection film (not illustrated) in the second position of emission.

The first split beam having passed through the first position of emission and the second split beam having passed through the second position of emission may be substantially parallel to each other and may each have a peak intensity that is about half of the peak intensity of the seed light falling on the parallel plane substrate 37a. The first and second split beams may each have a Gaussian distribution beam profile in the H direction. There may be a low-energy-density depressed portion between the first split beam and the second split beam.

As shown in FIG. 9B, the beam profile in the V direction may not substantially change.

In general, the central part of discharge in an amplifier may be strong in excitation and high in gain. Accordingly, by causing seed light having a low-energy-density depression in the central part of the beam profile in the H direction to be amplified by entering the amplifier PO, output light that is outputted from the amplifier PO may have a beam profile that is equivalent to a top-hat shape. This may suppress the unevenness in temperature in the optical elements such as the windows 20a and 20b and thus suppress the birefringence by the thermal stress.

### 5.3 Ninth Embodiment

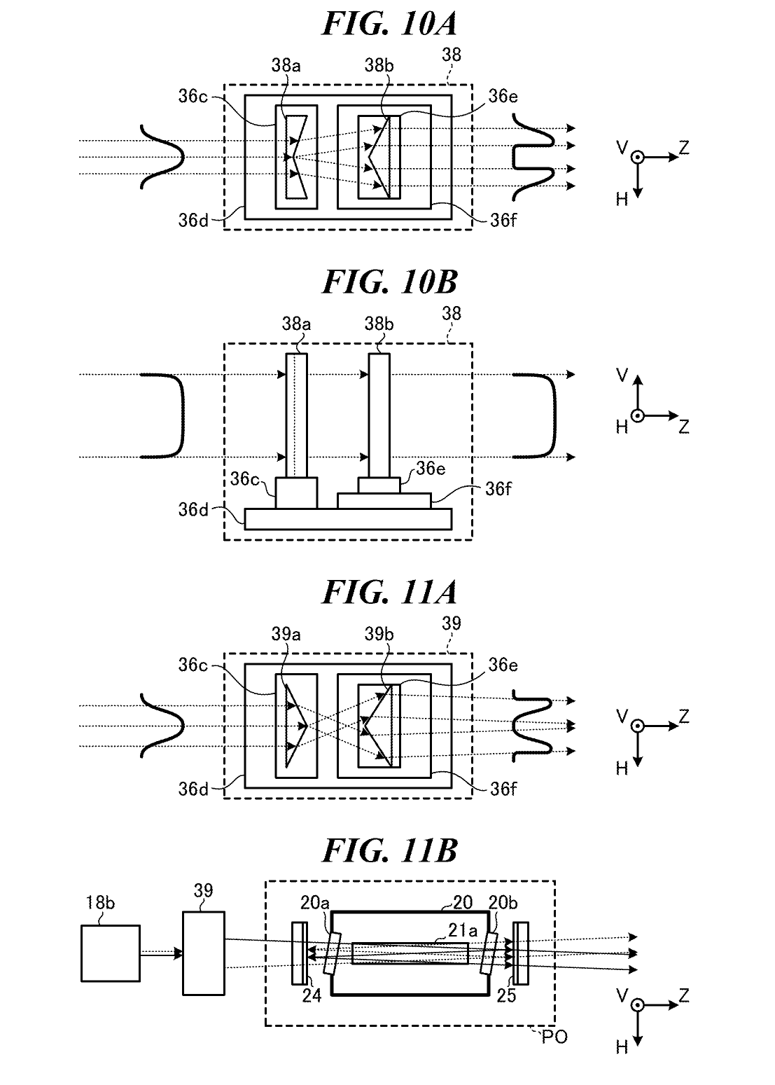

FIGS. 10A and 10B schematically illustrate a configuration of a transform optical system 38 that is used in an excimer laser apparatus according to the ninth embodiment. FIG. 10A shows a view from the V direction, and FIG. 10B shows a view from the H direction. The excimer laser apparatus according to the ninth embodiment may be the same as that according to the seventh embodiment, except that the transform optical system 38 is used.

The transform optical system 38 may include two prisms 38a and 38b. The prism 38a may have a concave pentagonal cross-section parallel to the ZH plane. The prism 38b may have an isosceles triangular cross-section parallel to the ZH plane. The prisms 38a and 38b may be shaped so as to form a rectangular prism as a whole when they are moved closer to each other and their sloped surfaces come into contact with each other with substantially no space therebetween.

The ninth embodiment may be the same as the seventh embodiment in terms of the configuration in which the prism 38a is fixed and the prism 38b is movable.

When passing through the prism 38a, seed light whose beam profile in the H direction has a Gaussian distribution shape may be refracted and split into beams that travel away from each other toward the sides of the positive and negative directions, respectively, of the H axis. When these beams pass through the prism 38b, the beam profile of the seed light may be turned into a beam profile having a low-energy-density depression in the central part of the beam profile in the H direction and having one peak of energy density at either end of the beam profile. One of the peaks at both ends may constitute a first split beam, and the other peak may constitute a second split beam.

As shown in. FIG. 10B, the beam profile in the V direction may not substantially change.

In general, the central part of discharge in an amplifier may be strong in excitation and high in gain. Accordingly, by causing seed light having a low-energy-density depression in the central part of the beam profile in the H direction to be amplified by entering the amplifier PO, output light that is outputted from the amplifier PO may have a beam profile that is equivalent to a top-hat shape. This may suppress the unevenness in temperature in the optical elements such as the windows 20a and 20b and thus suppress the birefringence by the thermal stress.

### 5.4 Tenth Embodiment

FIG. 11A schematically illustrates a configuration of a transform optical system 39 that is used in an excimer laser apparatus according to the tenth embodiment. FIG. 11A shows a view from the V direction. The excimer laser apparatus according to the tenth embodiment may be the same as that according to the seventh embodiment, except that the transform optical system 39 is used.

The transform optical system 39 may include two prisms 39a and 39b. The prisms 39a and 39b may each have an isosceles triangular cross-section parallel to the ZH plane. However, the isosceles triangular cross-section of the prism 39b may have a smaller vertex angle than that of the prism 39a.

The tenth embodiment may be the same as the seventh embodiment in terms of the configuration in which the prism 39a is fixed and the prism 39b is movable.

Seed light whose beam profile in the H direction has a Gaussian distribution shape may pass through the prisms 39a and 39b. The seed light having passed through the prisms 39a and 39b may have a beam profile having a low-energy-density depression in the central part of the beam profile in the H direction and having one peak of energy density at either end of the beam profile. One of the peaks at both ends may constitute a first split beam, and the other peak may constitute a second split beam.

However, in the tenth embodiment, as shown in FIG. 11, the first and second split beams may exit from the transform optical system 39 not in the same direction but in directions toward each other. The angle θ between each of the first and second split beams and the central axis of the amplifier may be 0 mrad<θ≦1.5 mrad. More preferably, the angle θ may be 0 mrad <θ≦1 mrad.

FIG. 11B illustrates an optical path in the amplifier PO in a case where the transform optical system 39 shown in FIG. 11A is used. As shown in FIG. 11B, the first and second split beams split by the transform optical system 39 may fall on the window 20a in positions that are away from the central axis of the amplifier PO in the +H and −H directions, respectively. The first and second split beams may approach the central axis of the amplifier PO by traveling back and forth through the resonator of the amplifier PO and may be amplified while filling a discharge region. This may suppress the unevenness in temperature in the optical elements such as the windows 20a and 20b and thus suppress the birefringence by the thermal stress.

The configuration in which the first and second split beams exit from the transform optical system in directions toward each other is not limited to such a configuration of the tenth embodiment in which the prisms are used. For example, by replacing the parallel plane substrate 37a shown in FIG. 9 with a wedge substrate having a tapered thickness, the first and second split beams may enter the amplifier PO in directions toward each other.

### 6. Variations of Amplifiers

### 6.1 Eleventh Embodiment

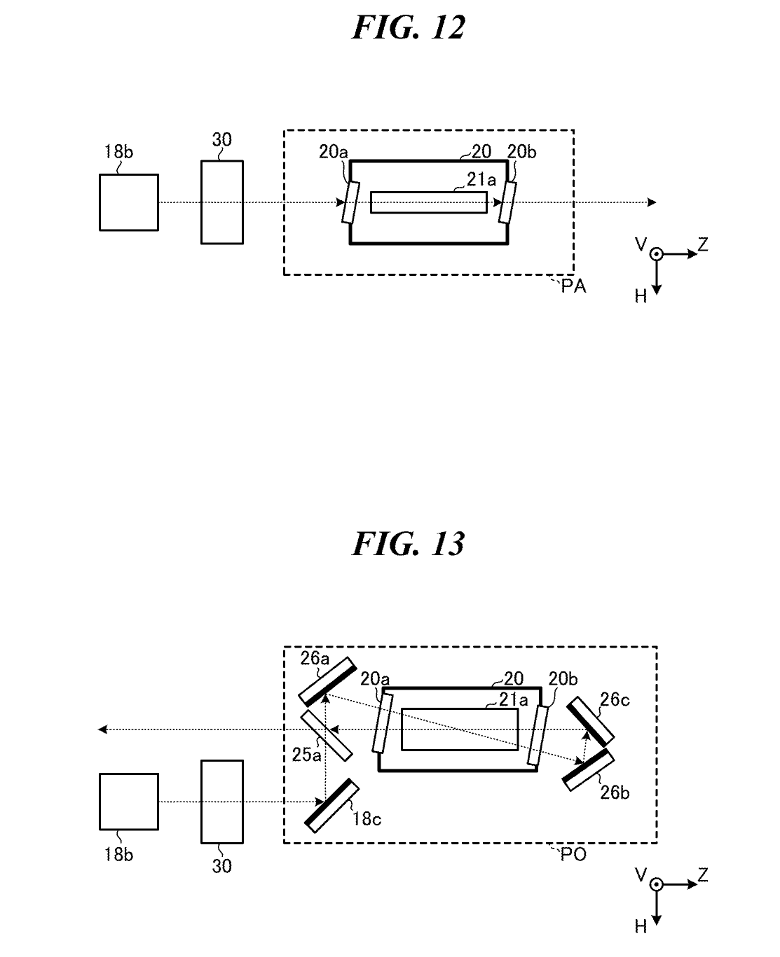

FIG. 12 schematically illustrates a configuration of an amplifier PA that is used in an excimer laser apparatus according to an eleventh embodiment. FIG. 12 shows a view from the V direction. The excimer laser apparatus according to the eleventh embodiment may be the same as those according to the first to tenth embodiments, except that the amplifier PA is used.

The amplifier PA may differ from the amplifier PO described with reference to FIG. 1A in that the amplifier PA includes no optical resonator. Seed light having entered the amplifier PA via the transform optical system 30 may be amplified by passing through an amplification region in the laser chamber 20 once and may then be outputted as a laser beam from the amplifier PA. Further, the amplifier PA may have a high reflection mirror disposed to allow the seed light to pass through the amplification region in the laser chamber 20 multiple times.

In the present embodiment, too, having the seed light transformed by the transform optical system 30 enter into the amplifier PA may suppress the unevenness in temperature in the windows 20a and 20b, thus suppress the birefringence effected by the thermal stress, and thus suppress the decrease in the purity of polarization.

### 6.2 Twelfth Embodiment

FIG. 13 schematically illustrates a configuration of an amplifier PO that is used in an excimer laser apparatus according to a twelfth embodiment. FIG. 13 shows a view from the V direction. The excimer laser apparatus according to the twelfth embodiment may be the same as those according to the first to tenth embodiments, except that the amplifier PO includes a ring resonator.

In the twelfth embodiment, the amplifier PO may include a high reflection mirror 18c, an output coupling mirror 25a, and high reflection mirrors 26a to 26c.

Seed light having passed through the transform optical system 30 may enter the amplifier PO. The seed light having entered the amplifier PO may be guided by the high reflection mirror 18c to the output coupling mirror 25a.

The amplifier PO may amplify the laser beam in such a way that the laser beam passes through the laser chamber 20 multiple times along a ring-shaped optical path constituted by the high reflection mirrors 26a to 26c and the output coupling mirror 25a.

The laser beam amplified by the amplifier PO may then be outputted as output light via the output coupling mirror 25a.

In the present embodiment, too, having the seed light transformed by the transform optical system 30 enter into the amplifier PO may suppress the unevenness in temperature in the windows 20a and 20b and thus suppress the birefringence by the thermal stress. This may result in suppression of the decrease in the purity of polarization.

The aforementioned descriptions are intended to be taken only as examples, and are not to be seen as limiting in any way. Accordingly, it will be clear to those skilled in the art that variations on the embodiments of the present disclosure may be made without departing from the scope of the appended claims.

The terms used in the present specification and in the entirety of the scope of the appended claims are to be interpreted as not being limiting. For example, wording such as “includes” or “is included” should be interpreted as not being limited to the item that is described as being included. Furthermore, “has” should be interpreted as not being limited to the item that is described as being had. Furthermore, the modifier “a” or “an” as used in the present specification and the scope of the appended claims should be interpreted as meaning “at least one” or “one or more”.

1. A laser apparatus comprising:
an oscillator configured to output seed light;
an amplifier including a laser chamber provided in an optical path of the seed light and a pair of discharge electrodes provided inside the laser chamber; and
a transform optical system provided in the optical path of the seed light between the oscillator and the amplifier and configured to transform the seed light in a way that suppresses a decrease in purity of polarization of a laser beam that is outputted from the amplifier.

2. The laser apparatus according to claim 1, wherein
the laser chamber includes an optical element provided in the optical path of the seed light, and
the transform optical system suppresses generation of thermal stress in the optical element and thus suppresses the decrease in the purity of polarization of the laser beam that is outputted from the amplifier.

3. The laser apparatus according to claim 1, wherein the transform optical system transforms the seed light in a way that decreases energy density in a central part of a beam profile in a direction orthogonal to a direction of discharge between the discharge electrodes.

4. The laser apparatus according to claim 3, wherein the transform optical system transforms the seed light in a way that the beam profile in the direction orthogonal to the direction of discharge between the discharge electrodes has a substantially top-hat shape.

5. The laser apparatus according to claim 3, wherein the transform optical system beam-expands the seed light in the direction orthogonal to the direction of discharge between the discharge electrodes.

6. The laser apparatus according to claim 3, wherein the transform optical system transforms the seed light into two beams placed side by side in the direction orthogonal to the direction of discharge between the discharge electrodes.

7. The laser apparatus according to claim 6, wherein the transform optical system emits the seed light so that the two beams travel in directions toward each other.

8. The laser apparatus according to claim 6, wherein
the amplifier further includes:
a rear mirror configured to transmit, toward the laser chamber, at least a portion of the seed light and reflect, toward the laser chamber, at least a portion of a laser beam amplified inside the laser chamber; and
an output coupling mirror provided on a side opposite to the rear mirror across the laser chamber and configured to reflect, toward the laser chamber, at least a portion of the laser beam amplified inside the laser chamber and transmit another portion of the laser beam as output light from the amplifier, and
the transform optical system emits the seed light in a way that the two beams pass through the rear mirror and enter the laser chamber.
